(19) United States
(12) Patent Application Publication
(10) Pub. No.: US 2010/0285849 A1
(43) Pub. Date: Nov. 11, 2010

(54) Method and Apparatus For Staged Approach Transient RF Detection And Sensor Power Saving

(75) Inventors: Niko Porjo, Piikkio (FI); Jakke Mäkelä, Turku (FI); Tom Ahola, Helsinki (FI); Joni Jantunen, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/515,185

(22) PCT Filed: Nov. 17, 2006
(86) PCT No.: PCT/IB2006/003227

§ 371 Date: Jun. 24, 2010

(51) Int. Cl. H04B 1/38

(52) U.S. Cl. 455/574

(57) ABSTRACT

A method includes receiving a first signal from an antenna of a device and at least one internal device signal in a low-energy consumption path, detecting a peak in at least one of the first signal and the at least one internal device signal, and activating a higher energy consumption path to analyze the first signal when the detected peak is not in one of the at least one internal device signal.

### BACKGROUND OF THE INVENTION

1. Field of the Invention

The teachings in accordance with the exemplary embodiments of this invention relate generally to an apparatus and a method for detecting lightning.

2. Brief Description of Prior Developments

There are emerging applications for the sensing of ambient electromagnetic fields, such as for use in lightning detection. One problem that arises when attempting to sense such fields is the difficulty involved when attempting to differentiate electromagnetic fields of interest from artificial noise sources, and, in particular, noise from the device itself (e.g. the signal coupled from the antenna of a mobile phone). A low-energy solution to this problem requires that the electromagnetic sensor be in a sleep state most of the time, and that it enter an awake state when there is potential activity. However, if the artificial and internal device noises cannot be distinguished from real natural sources, the result is that the sensor will be on almost continuously and power consumption will rise to undesirable levels.

It is possible to use software to separate artificial noise signals from genuine lightning signals after data is output from an EMI sensor. This is done in professional devices, such as the ThunderBolt™ portable lightning detector by Spectrum Electronics, Inc. However, in known existing detection sensor systems, the sensor is “passive” in the sense of always passing through the same whole signal to the software, and is not optimized for power saving by adjusting its own state.

As noted above, mobile devices and the environment in which they are generally operated often contain numerous non-lightning related RF signals that may cause EMI detection systems, particularly lightning detection systems, to be active all the time. When such a detection system is utilized in a mobile device, the result is the imposition of tight limits on power consumption. Fortunately, lightning has some unique features which facilitates its identification. For example, when measured at a single frequency with a narrow bandwidth, lightning produces a signal that is both highly impulsive (with rise times of a few microseconds or less) and quite continuous (for example, near 1 MHz the impulses from a lightning flash can last for up to a second). Many artificial signals are either impulsive (for example light switches, which cause a single peak lasting less than one millisecond) or continuous (for example noise from a LED driver) Thus, many EMI signals can be identified in a manner requiring a sufficiently low level of processing and power consumption that their impact on power consumption is acceptable. As a specific example, light switches typically produce a single extremely narrow peak which can be filtered out in various ways.

However, there exists a sub class of quasi-periodic signals that have an internal structure that make them difficult to identify from lightning induced signals. Specifically, their burst length is in the millisecond range and their internal structure contains higher frequencies, causing the signal to appear random in the frequencies used for lightning detection. An example of such a signal is that caused by a Global System for Mobile Communications receiver (GSM TX) burst that can be heard through car radios. Another example is the signal produced by an automobile turn signal which, when driven by a relay, produces a relatively periodic pulse series. While it is possible to utilize high level software requiring considerable processing power to identify such signals that mimic a lightning-generated signal, solutions for identifying such signals are not optimized for low power consumption.

### SUMMARY

In an exemplary aspect of the invention, a method includes receiving a first signal from an antenna of a device and at least one internal device signal in a low-energy consumption path, detecting a peak in at least one of the first signal and the at least one internal device signal, and activating a higher energy consumption path to analyze the first signal when the detected peak is not in one of the at least one internal device signal.

In another exemplary aspect of the invention, a mobile device includes a low energy consumption path configured to receive a first signal from an antenna and at least one internal device signal and to detect a peak in at least one of the first signal and the at least one internal device signal, a higher energy consumption path configured to receive and analyze the first signal when the detected peak is not in one of the at least one internal device signal, and a circuit block configured to control the operation of the low energy consumption path and the higher energy consumption path.

In another exemplary aspect of the invention, an apparatus includes a low energy consumption element for receiving a first signal from an antenna of a device and at least one internal device signal and detecting a peak in at least one of the first signal and the at least one internal device signal, and an element for activating a higher energy consumption path to analyze the first signal when the detected peak is not in one of the at least one internal device signal.

In another exemplary aspect of the invention, a method includes receiving a signal from an antenna of a device in a first circuit, creating a fingerprint of the signal, comparing the fingerprint to a first list of fingerprints of stored signal sources to produce a match between the fingerprint and at least one of the stored signal source fingerprints, and forwarding the fingerprint to a second circuit if the match is not produced.

In another exemplary aspect of the invention, a mobile device includes a first circuit configured to receive a signal from an antenna, to create a fingerprint of the signal, and to compare the fingerprint to a first list of fingerprints of stored signal sources to produce a match between the fingerprint and at least one of the stored signal source fingerprints, and a second circuit configured to receive the fingerprint if the match is not produced.

In another exemplary aspect of the invention, an apparatus includes an element for receiving a signal from an antenna of a device, an element for creating a fingerprint of the signal, an element for comparing the fingerprint to a first list of fingerprints of stored signal sources to produce a match between the fingerprint and at least one of the stored signal source fingerprints, and an element for forwarding the fingerprint to a circuit if the match is not produced.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 is a schematic diagram of an electromagnetic interference detection apparatus according to an exemplary embodiment of the invention;

FIG. 2 is a diagram of a sample and hold (SH) circuit according to an exemplary and non-limiting embodiment of the invention;

FIG. 3 is a diagram of a sample and hold (SH) circuit according to another exemplary and non-limiting embodiment of the invention;

FIG. 4 is a diagram of an apparatus for practicing the invention according to another exemplary and non-limiting embodiment of the invention

FIG. 5 is a diagram of the blocks of the EMI detection apparatus that are active when operating in Mode 1 according to an exemplary and non-limiting embodiment of the invention;

FIG. 6 is a diagram of the blocks of the EMI detection apparatus that are active when operating in Mode 2 according to an exemplary and non-limiting embodiment of the invention;

FIG. 7 is a flow diagram of a method according to an exemplary and non-limiting embodiment of the invention;

FIGS. 8a-8f are signal plots of EMI sources overlaid with the values of the fingerprint matrix derived therefrom according to exemplary and non-limiting embodiments of the invention;

FIG. 9 is a flow diagram of a method according to an exemplary and non-limiting embodiment of the invention;

FIG. 10 is a diagram of an apparatus for practicing the invention according to an exemplary and non-limiting embodiment of the invention; and

FIG. 11 is a diagram of the blocks of the EMI detection apparatus that are active when operating in Mode 3 according to an exemplary and non-limiting embodiment of the invention.

### DETAILED DESCRIPTION

Exemplary and non-limiting embodiments of the invention provide a sensor, associated hardware, and a method of operation to provide a staged approach to the detection of electromagnetic signals. Exemplary embodiments of the system enable the measurement and detection of ambient electromagnetic radiation levels by a sensor embedded in a device that is itself an electromagnetic interference (EMI) source (such as a mobile phone). While described with reference to exemplary embodiments wherein there is detected the occurrence of lightning, non-limiting embodiments of the invention extend to the detection of any and all EMI sources of interest.

Exemplary embodiments according to the invention employ a staged approach. As used herein, “staged approach” refers to a detection approach utilizing at least two signal paths or processing levels. In an exemplary embodiment, a low-quality, low-energy-consumption path and a more accurate high-energy-consumption path are utilized. As described more fully below, the high-energy path can be switched off to minimize power consumption. The EMI emission state of a host device is estimated, in a non-limiting example, by detecting changes in voltage levels of common power supply nets as a function of frequency. This information is used to prohibit the propagation of faulty signals in the analysis path and to relax the requirements of external spurious signal detection and filtering.

With reference to FIG. 10, there is illustrated a schematic diagram of a device for implementing exemplary and non-limiting embodiments of the invention. A host device 100 includes an antenna 105 for receiving EMI signals that serve as input to EMI detection apparatus 10. EMI detection apparatus 10 analyzes the input signal from antenna 105 as described below to detect occurrences of EMI. The detection results of EMI detection apparatus 10 can be utilized to control the operation of EMI detection apparatus 10 or can be outputted to be used as an input to a processing unit 101. Both EMI detection apparatus 10 and processing unit 101 are illustrated as coupled to, or otherwise in communication with, memories 103, 103′. Memories 103, 103′ can be formed of any memory medium capable of storing and retrieving digital data, including flash memory and registers, and may be separate from or form an integral part of, EMI detection apparatus 10 and processing unit 101. A power source 107, typically a battery, provides power to the components of EMI detection apparatus 10. While described with reference to a mobile phone, host device 100 can be any electronic device, particularly a portable or mobile device, including, but not limited to, mobile phones and personal digital assistants (PDAs).

Although differing in details, various exemplary and non-limiting embodiments described herein measure the voltage changes in power supply nets as a function of frequency. Voltage changes in the power supply nets are caused by the larger than zero output impedances of the supply (battery and capacitors) and the physical implementation of the net (i.e. resistance in the copper wires etc.) forming the host device 100 in which detection is performed. For the detection of host device 100 independent signals, the system has an antenna 105. The received signal information is converted to digital form by a peak detector (PKD) or through a simple AD converter as described more fully below. This information is then processed by a digital processor. As described more fully below, based upon the processing of the information, the digital processor can alter the operational mode or parameters of the detection system or signal the host device 100 that a valid signal has been found.

It should be noted that the time scale of detectable EMI sources range over several orders of magnitude. In the case of lightning strikes, the signals of interest can span over 100 ms though initial recognition can be made from pulses lasting only a few ms. Conversely, spurious signals originating in the host device 100 have a wide spectrum, particularly, for example, between 10 us and 1 ms. As described more fully below, several modes of operation are employed as warranted by different EMI environments. When there are only a few real signals present and the host device is in active mode, most of the signals detected through the antenna path can be correlated with signals in the paths measuring the host device signal emissions. Some functions, such as light emitting diode pulse width modulation (LED PWM) drivers and Global System for Mobile Communications (GSM) power amplifiers have a time domain behaviour that leaves short, relatively quiet periods, to be used to detect outside signals.

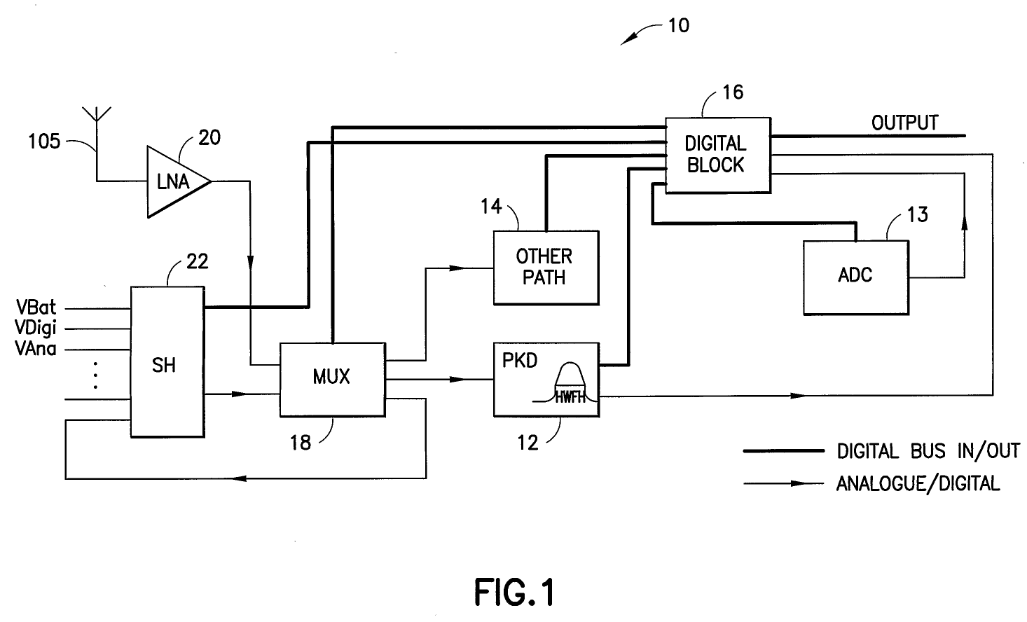

With reference to FIG. 1, there is illustrated a schematic diagram of an EMI detection apparatus 10 in accordance with exemplary and non-limiting embodiments of the invention. In practice, parts of the EMI detection apparatus 10 may form part of a StrikeAlert™ type lightning detector sensor the component parts of which are reused to lower the costs of adding device EMI state detection functionality as described herein. As illustrated, the design of the PKD 12 is power consumption optimised while the design of the “Other Path” block 14 is performance optimised.

According to the control signals from the digital block 16 (which can be a state machine) the Multiplexer (MUX) 18 selects either the amplified antenna signal (amplified via low noise amplifier (LNA) 20) or the output of the sample and hold circuit (SH) 22 as input to the PKD 12. The MUX 18 can, independent of the PKD 12 input, also output the antenna signal to the Other Path block 14. When the antenna signal is connected to the PKD 12, the Other Path 14 block can be powered down to reduce current consumption in the host device 100.

When the probability of lightning is very low (as in Mode 1, described more fully below) the LNA 20 output can form one of the inputs of the SH 22. In such a situation, almost all of the incoming signals are expected to be spurious (this can be known from component external information originating from the host device 100 or the network). When there is a low probability of lightning (as in Mode 2, described more fully below) the PKD 12 monitors the lightning situation directly from the antenna path. The SH 22 can still be running under the control of the digital block 16. When a detection is made by the PKD 12 from the antenna path, the SH 22 circuit is scanned to detect simultaneous internal noise sources. When lightning is probable (as in Mode 3, described more fully below), for example, when the PKD 12 has detected strong candidate signals and no internal candidates have been detected, the Other Path 14 block is utilized. At the same time, the PKD 12 is used to monitor the internal EMI state of the host device 100 (for example, a mobile phone) through the SH 22 inputs. As a result, the PKD 12 signal can be utilized to limit erroneous outputs from the digital block 16. Doing so lowers the host device 100 level current consumption as the CPU 101 can stay in sleep mode for longer periods. Alternatively, if the CPU 101 is active, it is not required to react to faulty interrupt requests from the lightning detector and consume calculating resources.

The SH 22 circuit has a plurality of inputs. In exemplary and non-limiting embodiments, these inputs include, at least, VBat, Vdigi, and Vana. VBat is the battery voltage. Vdigi represents a plurality of digital supply voltages commonly available in the system which currently, for example, are often about 1.5V but may be less than 1V. Vana represents a plurality of voltages regulated and filtered to be used by analogue circuits. Depending on the system design employed, one or several of the aforementioned inputs can serve as inputs to SH 22. In addition to the voltages discussed, various other voltages of interest can be similarly utilized.

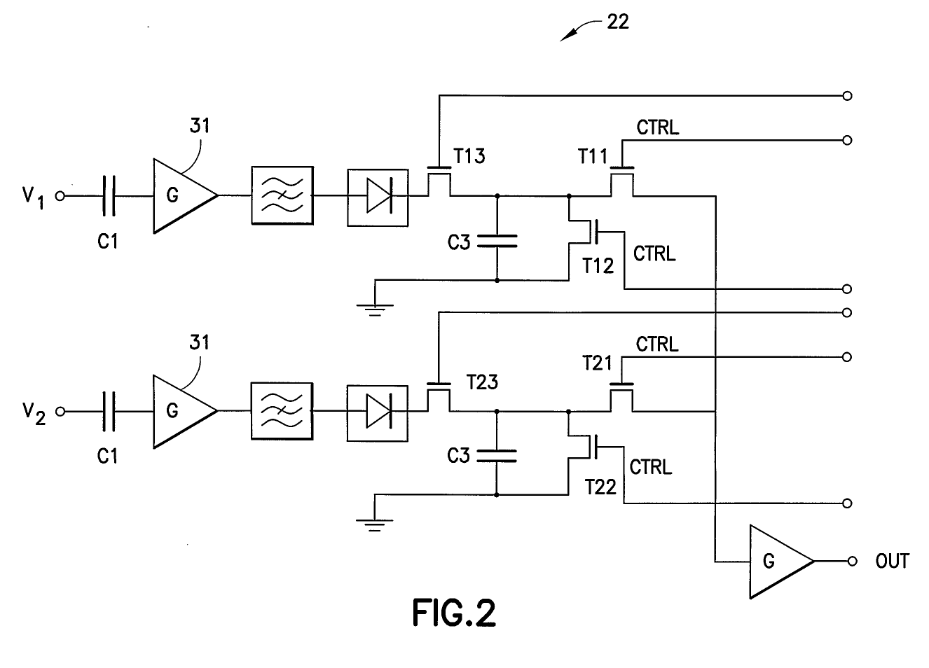

With reference to FIG. 2, there is illustrated an arrangement for SH 22 inputs according to an exemplary embodiment. As only the AC component of the inputs is of interest, the DC component is blocked by a capacitor C1. Depending on the system level filtering of power supply lines, a Gain stage (G) is added to enlarge the amplitude of the signal. A filtering block can be used to remove unwanted frequencies. Capacitor C3 holds the Signal coming from the rectifying block. As illustrated, only two input lines are shown but, as noted above, there can be more. Transistors T21, T22 and T13, T23 are used to reset the voltage on capacitor C3 in response to a signal from a digital control 16 block. Transistors T11, T12 are used to select which of the input paths is connected to the secondary gain stage. Output (Out) is connected to the PKD 12 through the MUX 18.

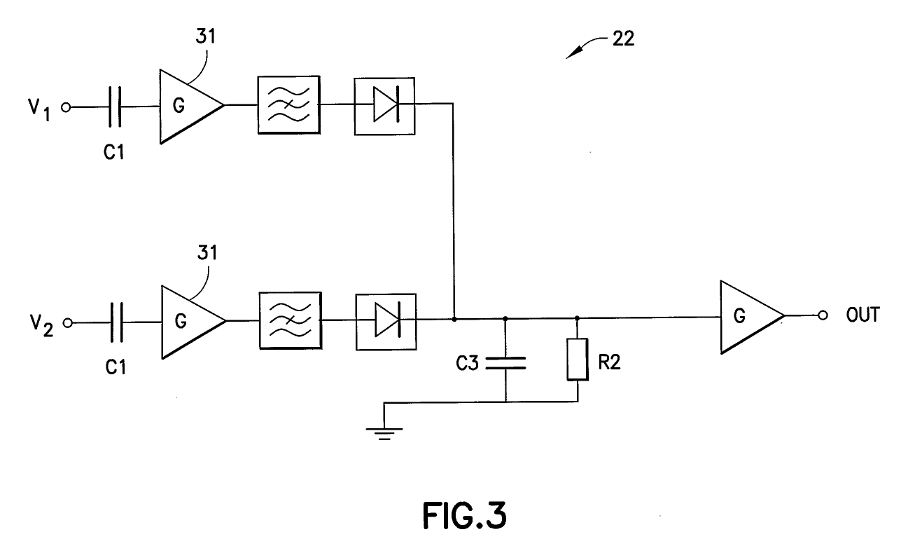

With reference to FIG. 3, there is illustrated another exemplary embodiment of a SH 22. As illustrated, the amplified signals are combined with an OR operation. This arrangement provides the benefit of combining the signals and reducing the need for control.

The gain in all the gain stages 31 in FIG. 2 and FIG. 3 can differ between blocks and are controllable from the digital block 16 (either actively by the circuit itself or by software in the host device 100). In exemplary embodiments, the PKD 12 of FIG. 1 is an analogue signal identification block which can have control parameters controlled by the digital block 16. These parameters can be used to optimise the performance of the PKD 12 for different input signals. In a very low power operation mode (Mode 1), i.e. when the antenna path is connected through the SH 22, the PKD 12 is following the time interleaved signal produced by the digital block 16 controlled SH 22 output. The digital block 16 is continually switching between different inputs of the SH 22 and, as the system has no DC input, all the SH 22 signal paths have a similar output until a signal is detected. In an exemplary embodiment, in Mode 1, ternary converter is included in the SH 22 and is utilized in place of the PKD 12. In such an embodiment, power consumption can be reduced as the converter can be implemented with switched capacitor (SC) logic. This ultra low power consumption could be used for example during deep winter in the northern parts of the globe when the probability of lightning is virtually zero.

In another exemplary and non-limiting embodiment, the functionalities of the SH 22 and the PKD 12 are integrated into an independent application-specific integrated circuit (ASIC). One advantage of this exemplary embodiment is that even if a lightning detector 10 is not integrated to the host device 100, there are other subsystems that are sensitive to EMI. Information produced by the ASIC can be used to alter the behaviour of such subsystems.

In another exemplary embodiment, the EMI detection circuitry 10 does not reuse parts of a lightning detector, and instead employs a dedicated detector specifically designed to detect device internal noise. An advantage of this exemplary embodiment is that even the use of the Other path block 14 in FIG. 1 can be avoided in case of strong internal emissions such as a GSM burst such as when the EMI detection path blocks a wake up signal from the PKD 12. Further, even the antenna path with its amplifier 20 and PKD 12 can be shut down in prolonged noise situations.

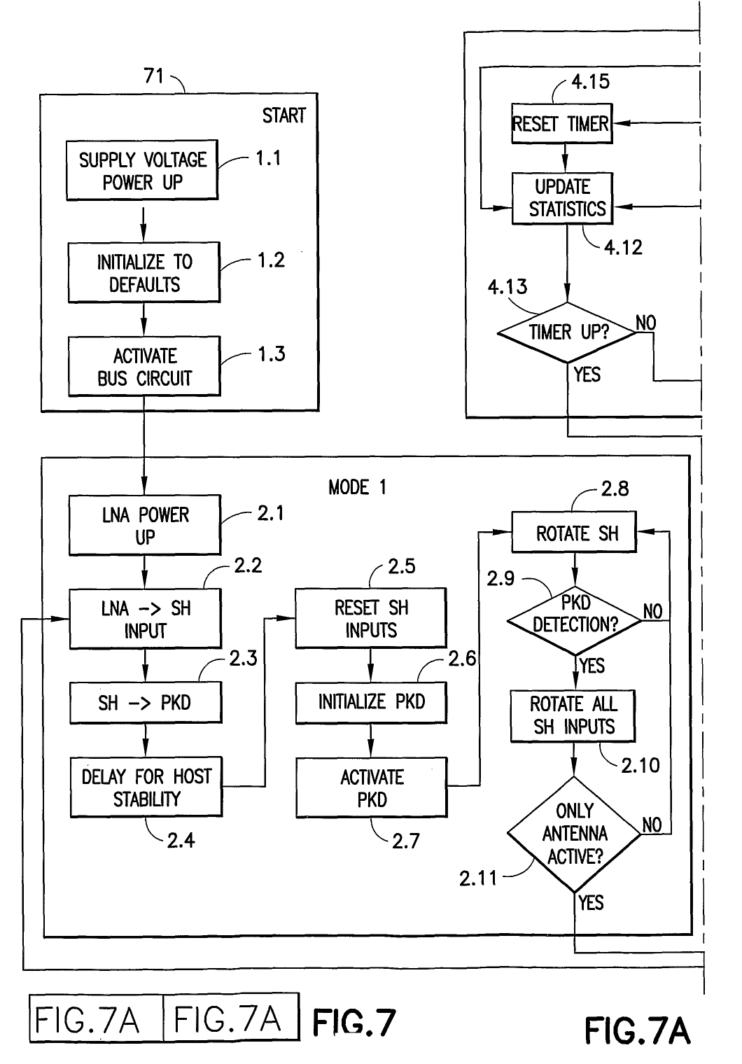

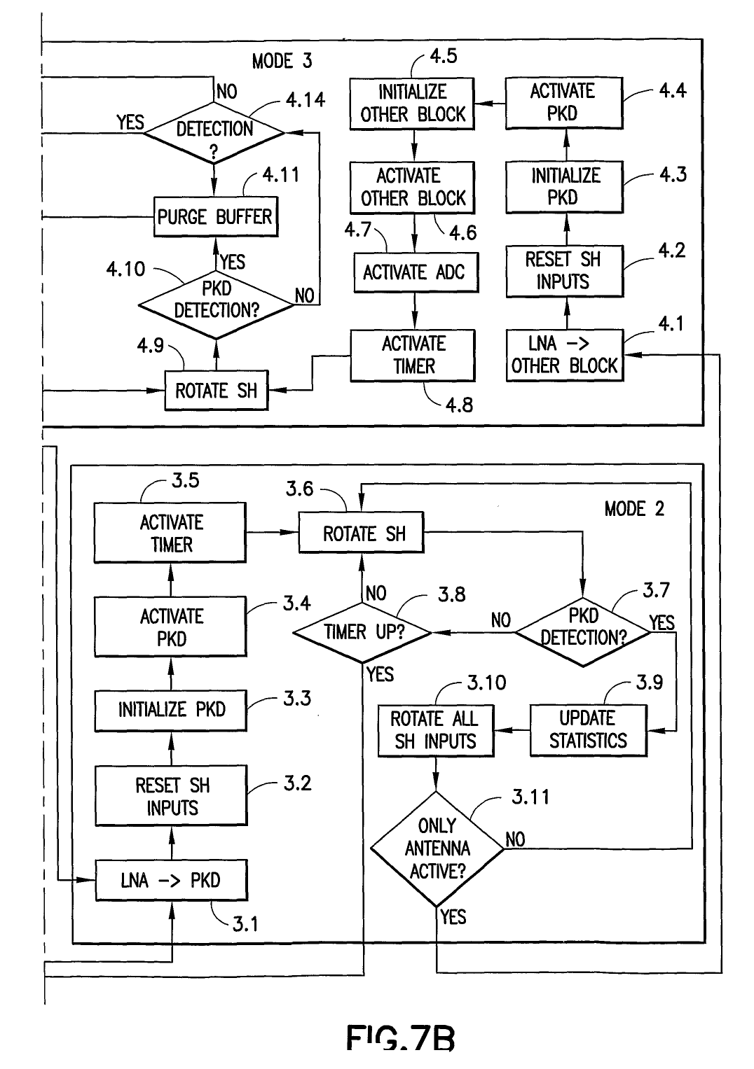

With reference to FIG. 7, there is illustrated a flow chart of an exemplary embodiment of a method for operating and otherwise utilizing the EMI detection circuit 10. The process commences at start frame 71. At step 1.1, the host device powers up and power is connected to this sub system. At step 1.2, the system is initialized with default values such as by hard coding or retrieving from memory. At step 1.3, a bus block is enabled to activate host device control.

After the processes of start frame 71 are completed, operation in Mode 1 commences. At step 2.1, the LNA 20 is powered up. At step 2.2, the LNA 20 output forms one of the inputs to the SH 22. At step 2.3, the SH 22 output forms an input to the PKD 12. At step 2.4, a predetermined time period is utilized to allow the host device 100 to start up and reach a stable state. At step 2.5, the SH 22 is rotated to reset the inputs. This ensures that no erroneous residual readings from start up are present. At steps 2.6 and 2.7, the PKD 12 is activated and initialized to Mode 1. At step 2.8, the SH 22 is rotated whereby one input is read and a previous input is reset. At step 2.9, a check is performed to determine if an EMI signal was detected. If not, processing proceeds back to step 2.8. If an EMI signal is detected, processing proceeds to step 2.10 whereat all SH 22 inputs are rotated to determine which inputs have been active. At step 2.11 a check is performed. If it is determined that several different channels are active, including the channels checking for noise sources, processing loops back to step 2.8. If it is determined that only the signal from the antenna is active, processing continues to Mode 2.

Upon entering into Mode 2, at step 3.1, the output of the LNA 20 is input to the PKD 12. At step 3.2, the inputs of the SH 22 circuit are reset in response to the previous change in the output of the LNA 20. At step 3.3, the PKD 12 is initialized to a Mode 2 specific setting and, at step 3.4, the PKD 12 is activated. At step 3.5, a timer is activated that is utilized to limit the amount of time spent in Mode 2 if no signal is found. At step 3.6, the SH 22 is rotated whereby an input is read and a previous input is reset. At step 3.7, if the PKD 12 has not triggered on an EMI signal, processing proceeds to step 3.8. If an EMI signal was detected, processing proceeds to step 3.9. At step 3.8, a check is performed to determine if the predetermined period of time measured by the timer has elapsed. If it has, processing continues to step 2.2. If not, processing proceeds to step 3.6. At step 3.9, statistics are updated in a memory. Specifically, a record is maintained of the EMI signals detected in Mode 2.Digital block 16 can adjust the operation of the system based upon the recorded statistics or the statistics can be output to the host device 100 for use, for example, by a CPU 101 of the host device 100. At step 3.10, the inputs to the SH 22 are rotated to determine which inputs are active. At step 3.11, if more than one input is active, processing loops back to step 3.6. If only the antenna input is active, processing proceeds to Mode 3.

Upon entering into Mode 3, the output of the LNA 20 is input into the Other path block 14 at step 4.1. At step 4.2, the SH 22 inputs are rest. At step 4.3, the PKD is initialized to a Mode 3 specific setting. At step 4.4, the PKD 12 is activated. At steps 4.5 and 4.6, the Other path block 14 is initialized and activated, respectively. At step 4.7, an analog-to-digital converter (ADC) 13 is activated. At step 4.8, a timer is activated to measure a predetermined period of time. The value of the predetermined period of time can differ from that measured in Mode 2 and described above. At step 4.9, the SH 22 circuit is rotated whereby one input is read and a previous input is reset. If, at step 4.10, the PKD 12 has not detected anything, processing proceeds to step 4.14. If an EMI signal is detected, processing continues to step 4.11 whereat an analysis data buffer is purged. The analysis data buffer is any memory storage device coupled to the digital block 16 that is utilized to store data in digital form for analysis or to ease the bus requirements of the raw data output. The purge is performed to remove data that is likely to contain internal interference signals. At step 4.12, the statistics are updated. At step 4.13, a check is performed to determine if the predetermined period of time has elapsed. If the time period has elapsed prior to the detection of a candidate EMI signal, processing loops to step 3.1. If the period of time has yet to elapse, processing loops to step 4.9. At step 4.14, a determination is made if an EMI detection has been made in the Other path block 14 by the digital block 16 based upon the data stored in or coupled to the digital block 16. If an EMI detection was made, processing continues to step 4.15 where the timer is reset and processing loops to step 4.12. If no EMI signal is detected, processing loops back to step 4.12.

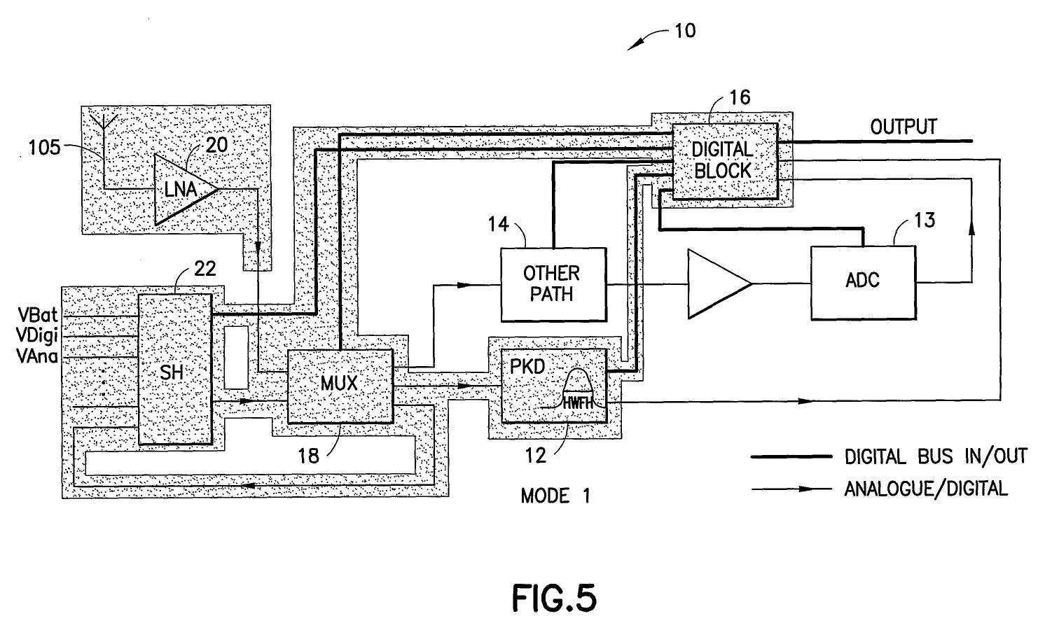

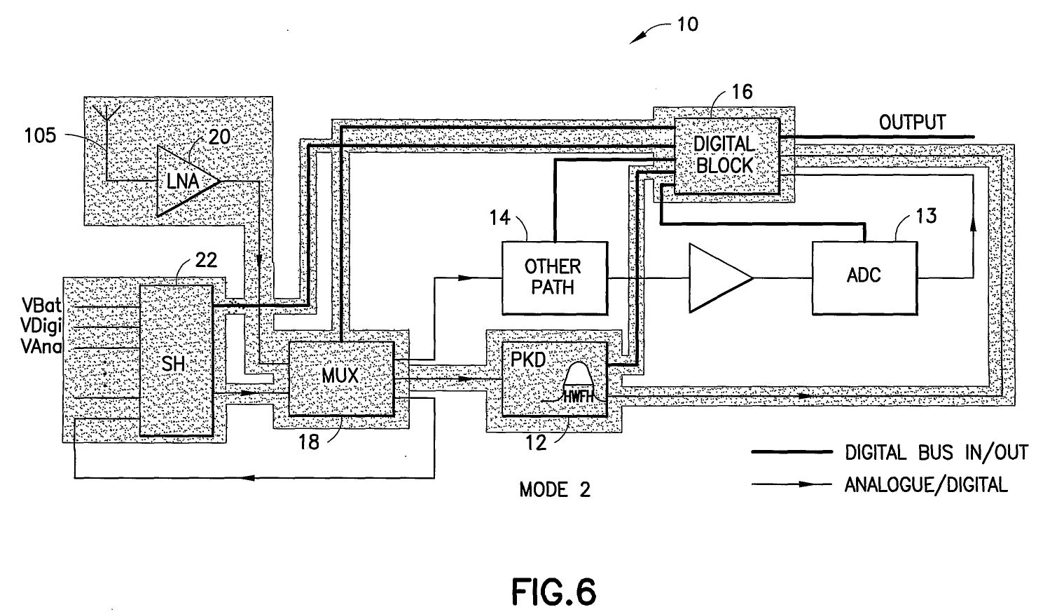

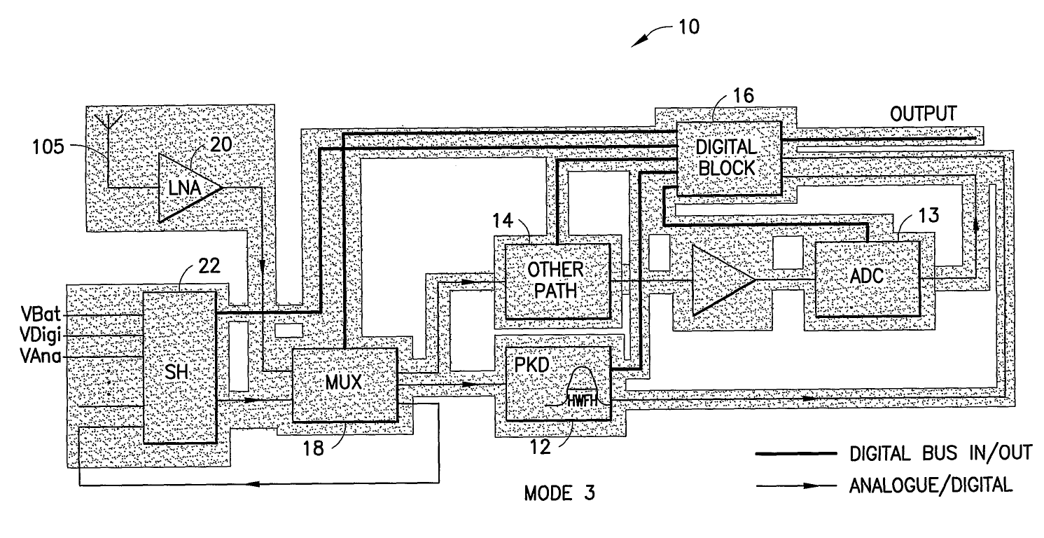

With reference to FIGS. 5, 6, and 11, there are illustrated the blocks of the EMI detection apparatus 10 that are active when operating in Mode 1, Mode 2, and Mode 3, respectively.

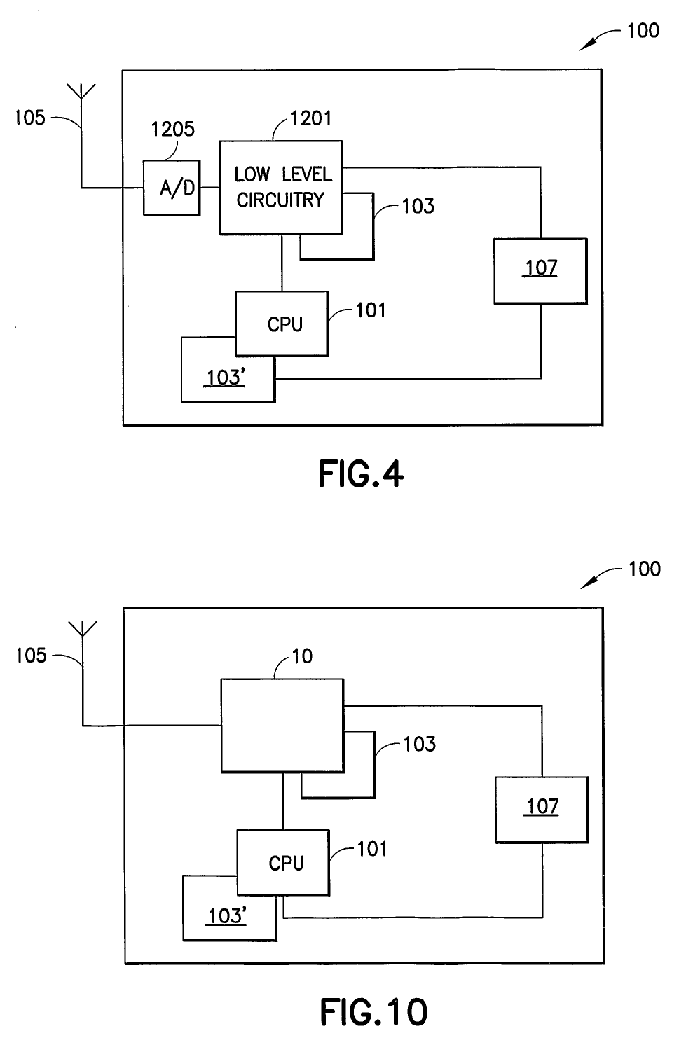

In addition to the staged approach utilizing at least two signal paths described above, exemplary and non-limiting embodiments of the invention can utilize multi-level signal processing to minimize the energy consumption of a lightning detector chip or module in a host device 100. In such exemplary embodiments, at least two levels are implemented using a low-level and low-power consumption circuitry implemented directly in low-level circuitry 1201, typically formed of hardware, and a higher-level signal processor or CPU 101 as illustrated with reference to FIG. 4.

With reference to FIG. 4, there is illustrated a schematic diagram of a device for implementing exemplary and non-limiting embodiments of the invention. A host device 100 includes an antenna 105 for receiving EMI signals that serve as input to the low-level circuitry 1201 via A/D converter 1205. low-level circuitry 1201 analyzes the input signal from antenna 105 as described below to detect occurrences of EMI. The detection results of EMI detection apparatus 10 can be utilized to control the operation of EMI detection apparatus 10 or can be outputted to be used as an input to a processing unit 101. Both low-level circuitry 1201 and processing unit 101 are illustrated as coupled to, or otherwise in communication with, memories 103, 103′. Memories 103, 103′ can be formed of any memory medium capable of storing and retrieving digital data, including flash memory and registers, and may be separate from or form an integral part of, EMI detection apparatus 10 and processing unit 101. A power source 107, typically a battery, provides power to the components of EMI detection apparatus 10. While described with reference to a mobile phone, host device 100 can be any electronic device, particularly a portable or mobile device, including, but not limited to, mobile phones and personal digital assistants (PDAs).

In an exemplary embodiment, the low-level circuitry 1201 processes only one impulse at a time. The low level circuitry is triggered by the reception of an EMI signal. Once triggered, the low-level circuitry 1201 creates a “fingerprint” of the impulse (described more fully below). The low-level circuitry 1201 has access to fingerprints previously identified and stored in memory 103 which is typically implemented in the form of a register or Flash memory. The low-level circuitry 1201 compares the fingerprint of the received EMI signal to the previously stored fingerprints. If a match is not made, the fingerprint, or the EMI signal from which the fingerprint is formed, is passed to the upper layer/high-level processor 101, typically a CPU.

The high-level processor 101 can store and process multiple signals. The high-level processor creates a history list, or record, of the EMI signals that it has received. The high-level processor proceeds to determine if the received fingerprint is likely to belong to an interference source. If a previously unidentified interference fingerprint is identified, the fingerprint is sent back to the low-level circuitry 1201 where the fingerprint is stored for future reference.

As used herein, “fingerprint” refers to simplified model of a more complex EMI signal wherein the fingerprint contains a sufficient amount of data to describe the EMI signal for purposes of identification. A variety of parameters may be analyzed to store a “fingerprint” of a given EMI signal. In an exemplary embodiment directed to lightning detection, the following data vector can be utilized: Define a threshold below which the signal is considered to be zero. For the N most intensive peaks in the signal (for example N=5), store

Ti (time of occurrence of signal from start, in milliseconds)

Li (length of time that signal is above threshold, in milliseconds)

Pi (peak amplitude of signal, here arbitrary units)

Ei (total energy emitted before the value goes to zero)

These four exemplary values are relatively easy to calculate in a hardware (HW) implementation. The resulting signal fingerprint obtained is then a N×4 matrix, requiring only a few Bytes of storage or data transfer.

The threshold level may be hard-coded into the system, but in an exemplary embodiment it can be adjusted, for example, when the noise level in the environment changes. In an another exemplary embodiment, there may be more than one threshold level, in which case the fingerprint can be stored as a vector of matrices or a tensor. In practice, this enables a very simple form of pattern recognition which can be particularly useful in distinguishing between lightning and artificial signals. Since the mathematics can be extended to these cases, the description below is simplified to refer only to the case of a single fixed threshold level.

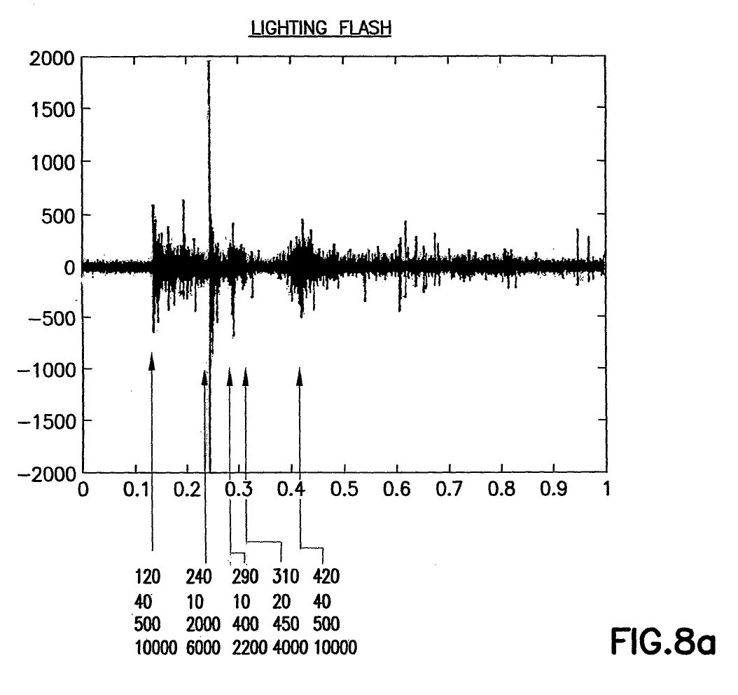

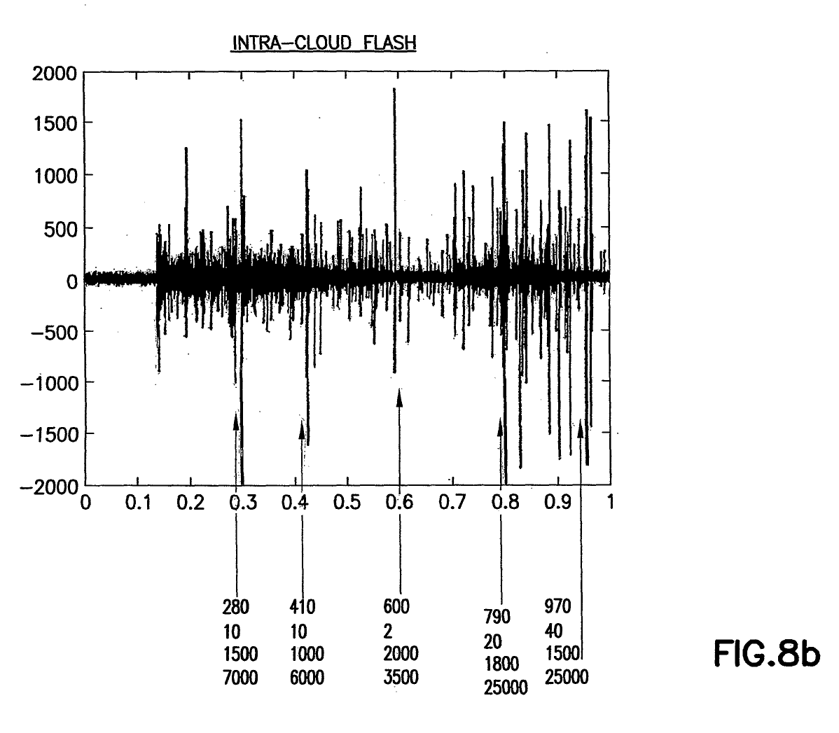

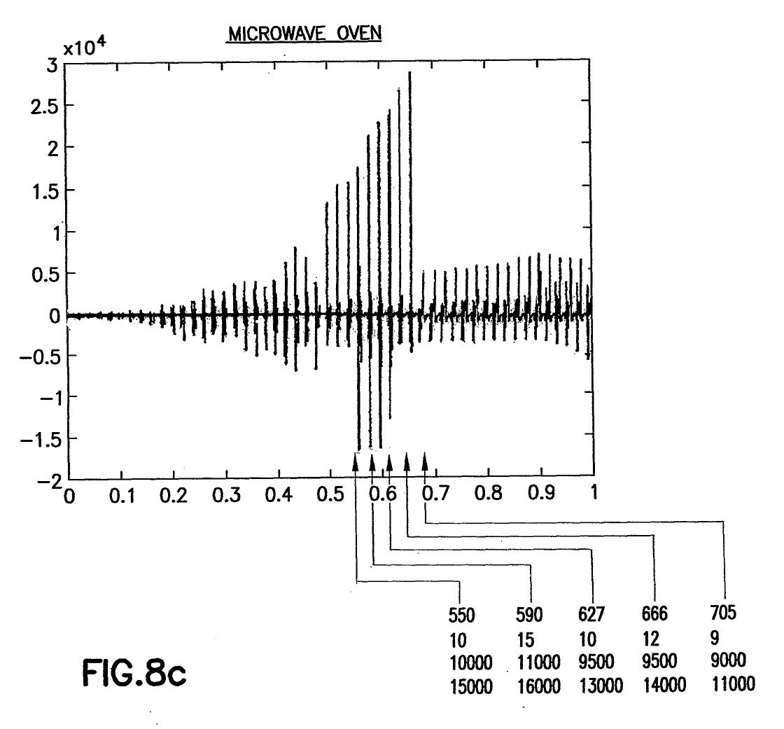

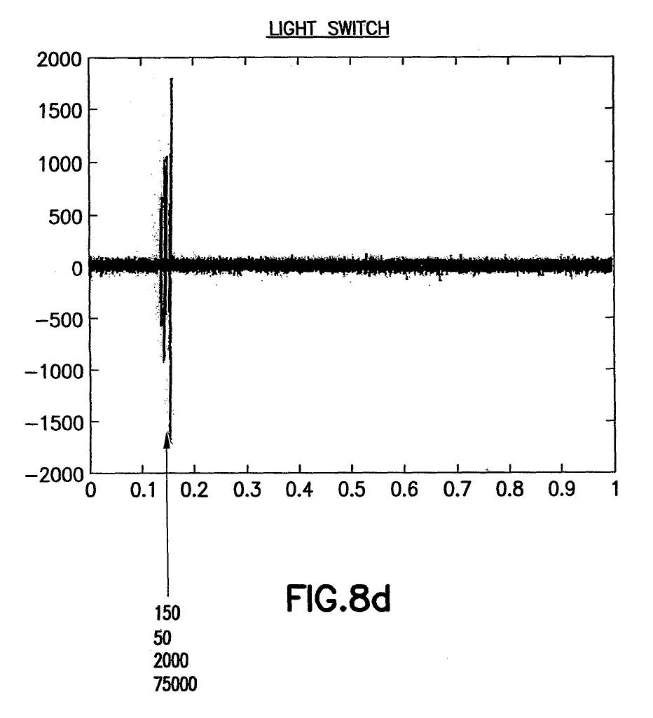

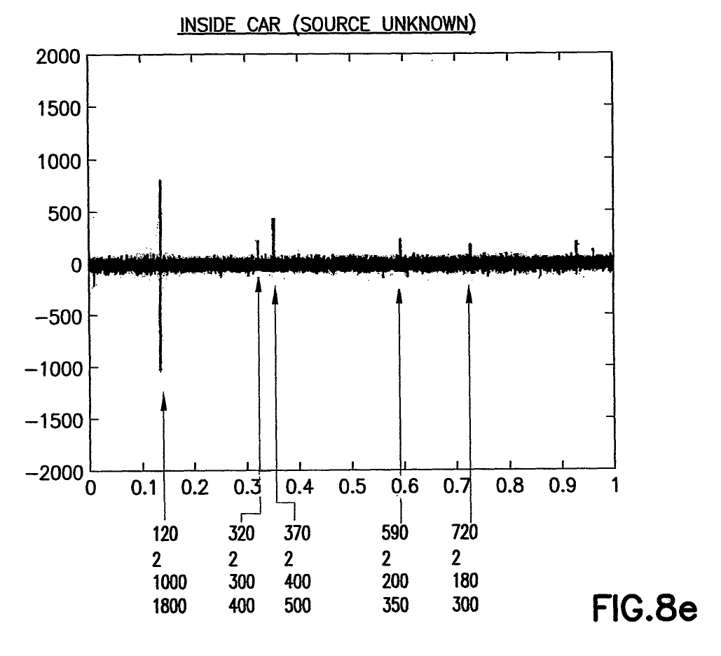

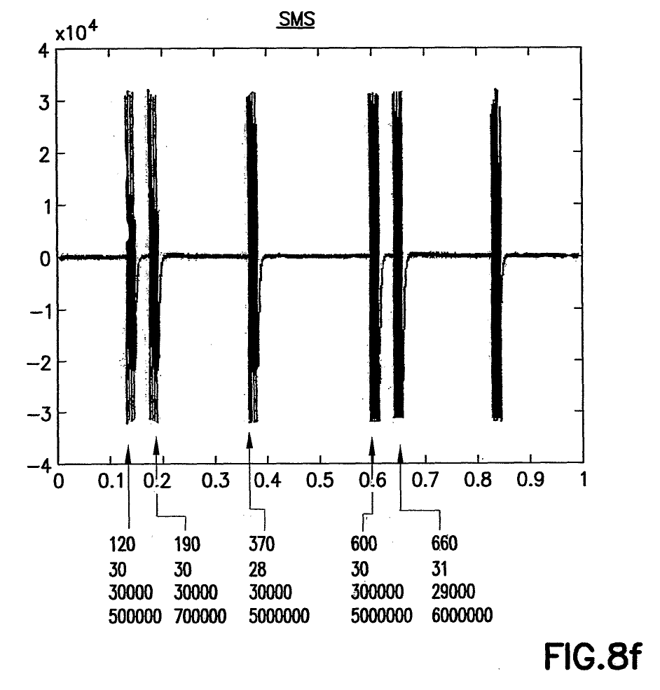

With reference to FIGS. 8a-8f, there are illustrated signal plots of various EMI sources overlaid with the values of the fingerprint matrix derived therefrom. As is evident the usefulness of the particular parameters chosen is derived from the following attributes:
the distances between the Ti tell whether the signal is periodic

the lengths Li can tell if the signal is periodic, and also, if they are all very small, the signal is likely to be interference

the peak Pi is a measure of the intensity of the signal

the energy Ei is also a measure of intensity; also, the difference between Ei/Ti and Pi can give a measure of the impulsiveness of the signal (if Pi>>Ei/Ti, most of the energy is concentrated in the main peak. If Pi˜Ei/Ti, the pulse is almost flat, implying almost certainly an artificial source as natural signals do not have such a characteristic).

Other typical parameters that may be recorded for use in the fingerprint includes Time above reference, Time above absolute value, Maximum deviation from reference, Maximum deviation from zero, Burst energy, and Burst frequency.

Given a fingerprint F and a list of interference source fingerprints S(j), one determines whether F matches closely any of the S(j). In theory, this can be accomplished by calculating the matrix distances |F−S(j)| and finding the minimum. However, it cannot be done quite this simply, as matching of fingerprints is slightly ambiguous, especially since not all of the peaks are necessarily caught in the signal. In an exemplary embodiment, the most important parameters to match are the times Ti and the lengths Li (the intensities can be more variable).

To implement the derivation and matching of fingerprints, as described more fully below, there are maintained three lists: a candidate list, a passive list and an active list. Each list has a number of fingerprint entries stored in a memory 103. For the passive list and the active list, this number may be decided at software (SW) design time or it can dynamically adjust during the running of the SW. To minimize the power consumption and memory requirements of the HW forming the low-level circuitry 1201, the listed parameters can be such that they are easily calculated from the analog-to-digital (AD) converted data. It is also possible to have dedicated analogue HW blocks that are separately AD converted to get a parameter.

A candidate parameter entry formed of a candidate parameter set is a list entry of a fingerprint from an EMI signal that has been detected one or more times but it is not known if the EMI signal is repeating or periodic. The candidate list can exist in the host device memory 103 and may be stored in non volatile memory. When new interference signal parameters, forming a fingerprint, are extracted, they are first added to the candidate list. The candidate list has a maximum number of entries that can not be exceeded at any one time. If the candidate list is full and can not be expanded when a new list entry, or fingerprint, has been detected or the list must be shortened, arbitration takes place in groups according to the following:
1. Candidate parameter sets that have not been updated or detected for the longest time are dropped first. This allows the system to adapt to changing environments.
2. Candidates that have small effect on the battery charging interval. That is, signals that may be detected every day but only a small number of times. Signals that are seen in bursts but those bursts last only relatively short time (tens of seconds at a time) and the bursts appear infrequently
3. Other signals

If a group has more than one member, arbitration takes place inside the group. A signal from the candidate list may be upgraded to interference signal status and moved to the passive list if one or several of its parameters exceed a pre set threshold for that parameter. An important quality of a candidate parameter set, or fingerprint, is that they can be modified if a new candidate parameter set is very close to an existing one. This is done to keep the number of interference signal parameter sets small so that they can fit in limited memory space on the sensor HW. To avoid extending some parameter sets to cover too much of the multidimensional parameter space, a set of rules gives hard limits to how much a parameter set can be extended. The candidate list can have entries at the first power up of the device.

A passive list entry is an identified interference signal, or fingerprint, that appears frequently and is well enough defined that it has a clear effect on system power consumption. Due to the limited memory space in the low-level circuitry 1201, only the most power consuming signals are stored in or coupled to the low-level circuitry 1201 and the passive list stores the other ones. Passive list entries are stored in host device memory 103′ and can be non volatile.

When an entry in the candidate list is upgraded to interference signal status, as described more fully below, it is removed from the candidate list and added to the passive list. If the passive list is full and can not be extended, or the list must be shortened, arbitration takes place. Entries that have not been detected for a long time are dropped first followed by signals having the smallest predicted impact on power consumption. A passive list entry can be moved to the active list if it has been detected often recently or it has significant power consumption importance.

Passive list entries can not be modified. When a fingerprint is detected and added to the passive list, the date and time of detection are recorded to maintain a record of the frequency of occurrence.

The active list is a collection of those interference signals, or fingerprints, that are currently considered to have the biggest effect on power consumption. Active list entries are stored both in the host device memory 103′ and in the low-level circuitry memory 103. When the HW detects them, time and date are recorded to keep track of their frequency of occurrence.

When an entry in the passive list exceeds a preset threshold it is added to the active list. If the active list is full, arbitration takes place. Before arbitration, information on the detection times of current active list entries is loaded to host device memory 103′. Entries that have not been detected for a long time are dropped first followed by signals having the smallest predicted impact on power consumption.

Active list entries are generally not modified. When they are detected, date and time of detection are recorded in the low-level circuitry 1201 to keep track of frequency of occurrence. The active list should have entries typical for the device included at the design time of the SW. These entries are initially stored in host device memory 103′ and not in the low-level circuitry 1201, even if it has flash memory, as omitting such device specific information from the HW before manufacturing tends to maximize production flexibility.

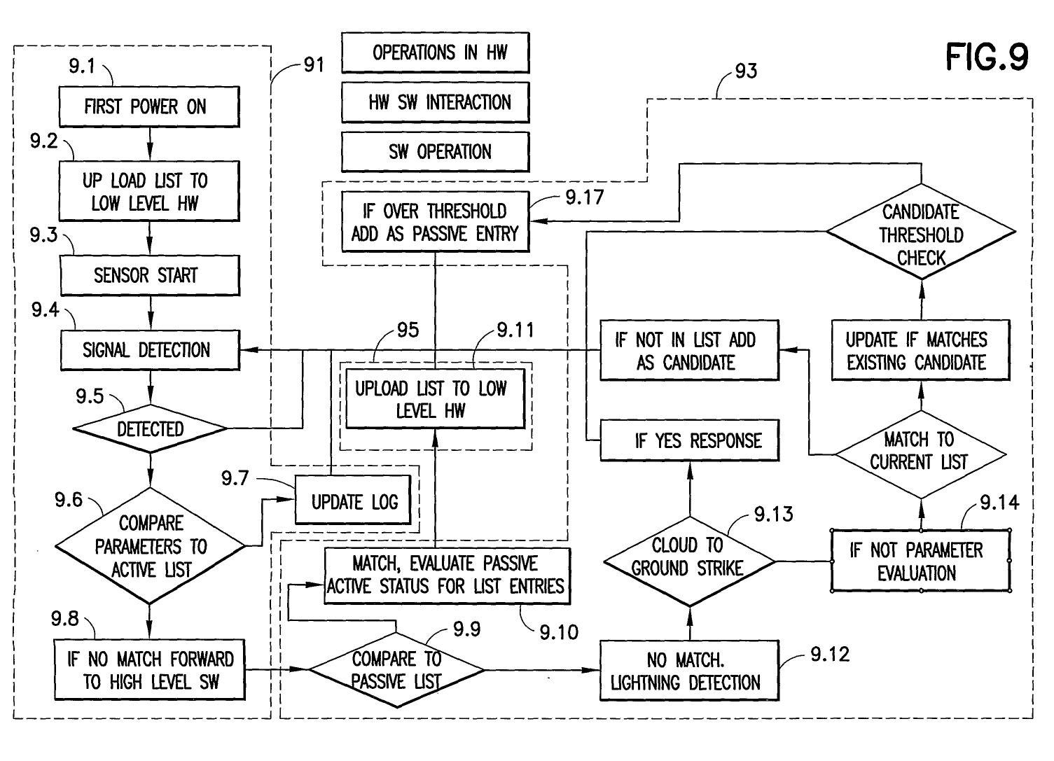

With reference to FIG. 9, there is illustrated a block diagram of the operation of EMI detection in accordance with above described exemplary embodiments. As illustrated, steps located within HW region 91 are performed on low-level circuitry 1201, steps located within SW region 93 are performed on a higher-level by software, and HW-SW interaction region 95 is formed of steps performed both by low-level circuitry 1201 and higher level SW, such as in CPU 101.

At step 9.1, the host device 100 is powered on. After manufacturing, the host device has an initial list of known interference signals stored in accessible memory. These signals are related to for example GSM, Bluetooth, etc. and are known to come from the normal operation of the host device. In addition, there are stored additional signals that are likely to be detected, for example, from engine spark plugs or fluorescent lighting drivers.

At step 9.2, if the low-level circuitry 1201 does not share memory 103 with the CPU 101 running the high level SW (which is likely the case due to architectural and power consumption restrictions) the initial list is first uploaded to the low-level circuitry 1201 specific memory 103. If the low-level circuitry 1201 has flash memory, the initial list can also be loaded during subcontractor manufacturing but doing so will likely lead to complications in manufacturing as different host devices 100 will likely need different initial lists depending on their noise sources.

At step 9.3, the low-level circuitry 1201 sensor is started. If the host device 100 has been shut down completely, the initial list will need to be uploaded if no flash memory present in the sensor component. At step 9.4, EMI signal detection is performed. It is at this step that the low-level circuitry 1201 spends most of its time. Detection of an EMI signal may take various forms. At step 9.5, if no signal is detected, processing loops back to step 9.4 and signal detection continues.

At step 9.6, if a likely signal has been detected, parameters saved in the list are extracted and a comparison is made to the active list saved in low-level circuitry memory 103. In an exemplary embodiment, an analog or digital circuit extracts the parameters continuously in real time and a parallel process compares them to the active list. If a detection circuitry triggers at the time when there is a match to the list the trigger is considered less likely to be genuine and the decision matrix will be less likely to give a result that the matter needs to escalated to the high-level CPU 101. The extracted parameters are linked with the actual signal and forwarded up the chain.

If a match is made, at step 9.7, a log is updated to show that a list entry has been used to block a signal. This log will be used when evaluating which entry needs to be dropped if the list is full and there are signals in the passive list that need to be upgraded to active status. If no match is made, the detected signal is escalated to the higher-level SW in CPU 101 at step 9.8.

At step 9.9, the extracted parameters forming the fingerprint of the detected signal are compared to the passive list entries. If a match to the passive list is found, a counter for the entry is incremented at step 9.10. In addition, the log from the low-level circuitry 1201 component is downloaded. A selection from the passive and active lists is done based for example on number of hits, frequency of hits in some time frame, etc., and the active and passive lists are created. Processing proceeds to step 9.11 where the new active list is uploaded to the low-level HW component memory. If needed, the logs in the component are initialized.

If no match from the passive list is found, the signal goes to the SW lightning detection algorithm at step 9.12 At step 9.13, the signal is evaluated to determine if it is a lightning related signal. If the signal is determined to be a lightning strike signal, the host device 100 is alerted and reacts in a desired manner. Processing proceeds to the low-level circuitry 1201 where signal detection continues.

If a lightning signal is not found, the signal is evaluated at step 9.14 and, if the signal fits the general criteria for list entries, the relevant parameters are extracted. Due to the nature of the received signals, there will rarely be a precise match between the detected signal and archived fingerprints. The new parameters comprising the fingerprint of the detected signal are compared to existing fingerprint candidates and, if there is a sufficiently close match, the existing candidates are modified. If the new parameters are not close to any of the parameter sets for the old signals, they are added as candidate signals at step 9.15. If the candidate list is full, arbitration takes place and one of the candidates is dropped from the list.

If an existing candidate parameter set is very close to the parameters of the detected signal, processing continues to step 9.16. If expanding the old set does not violate maximum parameter set laxness rules the new parameters are stored for future reference. This check is necessary to avoid situations where the parameter sets gradually expand to cover an area that will eventually block some genuine lightning signals. The candidate entry parameter for occurrence frequency is updated.

Lastly, at step 9.17, if the candidate has been detected enough times or frequently enough, it will be recognized as a interference description and moved to the passive list. If the threshold has not been exceeded, signal detection continues.

The embodiments of this invention may be implemented by computer software executable by a data processor of the mobile device 100, such as the data processor 101, or by hardware, such as low-level circuitry 1201, or by a combination of software and hardware. Further in this regard it should be noted that the various blocks of the logic flow diagrams of FIGS. 7 and 9 may represent program steps, or interconnected logic circuits, blocks and functions, or a combination of program steps and logic circuits, blocks and functions.

The memory 103, 103′ may be of any type suitable to the local technical environment and may be implemented using any suitable data storage technology, such as semiconductor-based memory devices, magnetic memory devices and systems, optical memory devices and systems, fixed memory and removable memory. The data processor 43 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided, by way of exemplary and non-limiting examples, a full and informative description for carrying out the invention. However, various modifications and adaptations may become apparent to those skilled in the relevant art in view of the foregoing description, when read in conjunction with the accompanying drawings and the appended claims.

Furthermore, some of the features of the preferred embodiments described above could be used without the corresponding use of other features. As such, the foregoing description should be considered as merely illustrative of the invention, and not limiting the invention.

1. A method comprising:
receiving a first signal from an antenna of a device and at least one internal device signal in a low-energy consumption path;
detecting a peak in at least one of said first signal and said at least one internal device signal; and
activating a higher energy consumption path to analyze said first signal when said detected peak is not in one of said at least one internal device signal.

2. The method of claim 1 wherein said activation of said low-energy consumption path and said higher energy consumption path is controlled by a digital block.

3. The method of claim 1 further comprising determining in said higher energy consumption path if said first signal is an electromagnetic interference (EMI) signal.

4. The method of claim 3 further comprising altering an operation of at least one of said low-energy consumption path and said higher energy consumption path in response to said determination.

5. The method of claim 3 further comprising altering an operation of said device in response to said determination.

6. The method of claim 3 comprising updating a statistic in response to said determination of said EMI signal.

7-32. (canceled)

33. An apparatus comprising:
low energy consumption path configured to receive a first signal from an antenna and at least one internal device signal and to detect a peak in at least one of said first signal and said at least one internal device signal; and
a higher energy consumption path configured to analyze said first signal when said detected peak is not in one of said at least one internal device signal.

34. The apparatus of claim 33 wherein said higher energy consumption path is configured to determine if said first signal is an electromagnetic interference (EMI) signal.

35. The apparatus of claim 33 wherein said activating means comprises a circuit block configured to control the operation of said low energy consumption path and said higher energy consumption path.

36. The apparatus of claim 35 wherein said circuit block is configured to alter an operation of at least one of said low-energy consumption path and said higher energy consumption path in response to said determination.

37. The apparatus of claim 35 wherein said circuit block is configured to alter an operation of the mobile device in response to said determination.

38. The apparatus of claim 35 wherein said circuit block is configured to update a statistic in response to said determination of said EMI signal.

39. A method comprising:
receiving a signal from an antenna of a device in a first circuit;
creating a fingerprint of said signal;
comparing said fingerprint to a first list of fingerprints of stored signal sources to produce a match between said fingerprint and at least one of said stored signal source fingerprints; and
forwarding said fingerprint to a second circuit if said match is not produced.

40. The method of claim 39 further comprising comparing said fingerprint to a second list of fingerprints of stored signal sources in said second circuit to produce a match between said fingerprint and at least one of said signal source fingerprints stored in said second list.

41. The method of claim 40 comprising, if said match between said fingerprint and at least one of said signal source fingerprints stored in said second list is not produced, storing said fingerprint in said first list.

42. The method of claim 39 wherein creating said fingerprint comprises recording a plurality of parameters at each of a predetermined number of peaks above a threshold in said signal.

43. An apparatus, comprising:
A first circuit configured to receive a signal from an antenna, to create a fingerprint of said signal, and to compare said fingerprint to a first list of fingerprints of stored signal sources to produce a match between said fingerprint and at least one of said stored signal source fingerprints; and
a second circuit configured to receive said fingerprint if said match is not produced.

44. An apparatus of claim 43 wherein said second circuit is configured to compare said fingerprint to a second list of fingerprints of stored signal sources in said second circuit to produce a match between said fingerprint and at least one of said signal source fingerprints stored in said second list.

45. An apparatus of claim 43 wherein said high-level processor is configured to store said fingerprint in said first list if said match between said fingerprint and at least one of said signal source fingerprints stored in said second list is not produced.

46. An apparatus of claim 43 wherein said fingerprint comprises a plurality of parameters each recorded at one of a predetermined number of peaks above a threshold value in said signal.
